(19) United States
(12) Patent Application Publication
(10) Pub. No.: US 2018/0004320 A1
(43) Pub. Date: Jan. 4, 2018

(54) COMBINED FORCE AND TOUCH SENSOR

(71) Applicant: SYNAPTICS INCORPORATED, San Jose, CA (US)

(72) Inventors: Igor POLISHCHUK, Fremont, CA (US); Joseph Kurth REYNOLDS, San Jose, CA (US)

(21) Appl. No.: 15/199,371

(22) Filed: Jun. 30, 2016

(51) Int. Cl. G06F 3/044; G06F 3/041

(52) U.S. Cl. CPC G06F 3/044; G06F 3/0414

(57) ABSTRACT

This disclosure generally provides input devices, processing systems and methods for touch and force sensing utilizing combination sensor conductors. The combination sensor conductors are configurable as capacitive sensor conductors and force sensor conductors via operation of a processing system.

### BACKGROUND

### Field

Embodiments of the present invention generally relate to input devices for touch sensing, and more specifically, to input devices can perform both touch and force sensing.

### Background of the Invention

Input devices including proximity sensor devices (also commonly called touchpads or touch sensor devices) are widely used in a variety of electronic systems. A proximity sensor device typically includes a sensing region, often demarked by a surface, in which the proximity sensor device determines the presence, location and/or motion of one or more input objects. Proximity sensor devices may be used to provide interfaces for the electronic system. For example, proximity sensor devices are often used as input devices for larger computing systems (such as opaque touchpads integrated in, or peripheral to, notebook or desktop computers). Proximity sensor devices are also often used in smaller computing systems (such as touch screens integrated in cellular phones).

Some input devices have integrated force sensors. However, most force sensor integrations require dedicated force sensor electrodes and associated routing. The sensor electrodes and associated routing undesirably add fabrication and material costs to the input device, and often undesirably add to the thickness and or size of the touch and/or force sensing components. Moreover, adding routing for additional force sensor electrodes undesirably consumes space within the input device, thus leaving less space available for other components which may reduce functionality.

Thus, there is a need for an improved input device that enables both touch and force sensing.

### BRIEF SUMMARY OF THE INVENTION

This disclosure generally provides input devices, processing systems and methods for touch and force sensing utilizing combination sensor conductors. The combination sensor conductors are configurable as capacitive sensor conductors and force sensor conductors via operation of a processing system.

In one example, an input device is provided that includes an input surface, a plurality of combination sensor conductors, a display configured to display images through the input surface, and a processing system communicatively coupled to the plurality of combination sensor conductors. The plurality of combination sensor conductors includes a first combination sensor conductor and a second combination sensor conductor. The first combination sensor conductor is configurable between being a first capacitive sensor conductor of a plurality of capacitive sensor conductors and a first force sensor conductor. The first capacitive sensor conductor and the first force sensor conductor share a same first conductive portion. The second combination sensor conductor is configurable between being a second capacitive sensor conductor of the plurality of capacitive sensor conductors and a second force sensor conductor. The second capacitive sensor conductor and the second force sensor conductor share a same second conductive portion. The processing system is configured to determine positional information for an input object present in a sensing region overlapping the input surface using at least the first capacitive sensor conductor of the plurality of capacitive sensor conductors, and determine force applied to the input surface of the display by the input object based on a change in a first resistance across the first force sensor conductor and a change in a second resistance across the second force sensor conductor.

In another example, a processing system is provided. The processing system includes a driver module and a receiver module. The driver module is configured to drive a plurality of combination sensor conductors during a first mode for capacitive sensing. The plurality of combination sensor conductors includes a first combination sensor conductor and a second combination sensor conductor. The first combination sensor conductor is configurable between being a first capacitive sensor conductor of a plurality of capacitive sensor conductors and a first force sensor conductor of a plurality of force sensor conductors. The first capacitive sensor conductor and the first force sensor conductor share a same first conductive portion. The second combination sensor conductor is configurable between being a second capacitive sensor conductor of the plurality of capacitive sensor conductors and a second force sensor conductor of the plurality of force sensor conductors. The second capacitive sensor conductor and the second force sensor conductor share a same second conductive portion. The driver module is also configured to drive at least the first and second force sensor conductors during a second mode. The receiver module is configured to receive first resulting signals indicative of a position of the input object interfacing with an input surface of the input device while the driver module is operating in the first mode, and receive second resulting signals indicative of a force of the input object interfacing with the input surface while the driver module is operating in the second mode.

In another example, a method for sensing force and position using an input device is provided. The method includes driving a plurality of combination sensor conductors during a first mode. The plurality of combination sensor conductors includes a first combination sensor conductor and a second combination sensor conductor. The first combination sensor conductor is configurable between being a first capacitive sensor conductor of a plurality of capacitive sensor conductors and a first force sensor conductor of a plurality of force sensor conductors. The first capacitive sensor conductor and the first force sensor conductor share a same first conductive portion. The second combination sensor conductor is configurable between being a second capacitive sensor conductor of the plurality of capacitive sensor conductors and a second force sensor conductor of the plurality of force sensor conductors. The second capacitive sensor conductor and the second force sensor conductor share a same second conductive portion. The method also includes driving the first force sensor conductor of the plurality of the force sensor conductors during a second mode, determining a position of an input object interfacing with an input surface of the input device from resulting signals comprising effects of at least one signal driven during the first mode on the plurality of combination sensor conductors, and determining force of the input object applied to the input surface based on a first change in resistance across the first force sensor conductor and a second change in resistance across the second force sensor conductor occurring during the second mode.

### BRIEF DESCRIPTION OF DRAWINGS

So that the manner in which the above recited features of the present invention can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is schematic diagram of an exemplary input device integrated with a display device;

FIG. 2 is a schematic plan view of the input device of FIG. 1 illustrating an exemplary pattern of sensor conductors of the input device having combination sensor conductors coupled to a processing system;

FIG. 3 is a partial illustration of the input device showing an exemplary configuration of combination sensor conductors that may be utilized in the input device of FIG. 1, among others;

FIG. 4 is a partial illustration of the input device showing an exemplary configuration of combination sensor conductors that may be utilized in the input device of FIG. 1, among others;

FIG. 5 is a partial illustration of the input device showing an exemplary configuration of combination sensor conductors that may be utilized in the input device of FIG. 1, among others;

FIG. 6 is a schematic block circuit diagram of an exemplary configuration of combination sensor conductors coupled to the processing system that may be utilized in the input device of FIG. 1, among others;

FIGS. 7 and 8 are schematic sectional views of an input device comparatively illustrating deflection of an input surface and force sensor conductors upon application of a force to the input surface; and

FIG. 9 is a flow diagram of a method for operating an input device.

To facilitate understanding, identical reference numerals have been used, where possible, to designate identical elements that are common to the figures. It is contemplated that elements disclosed in one embodiment may be beneficially utilized on other embodiments without specific recitation. The drawings referred to here should not be understood as being drawn to scale unless specifically noted. Also, the drawings are often simplified and details or components omitted for clarity of presentation and explanation. The drawings and discussion serve to explain principles discussed below, where like designations denote like elements.

### DETAILED DESCRIPTION

The following detailed description is merely exemplary in nature and is not intended to limit the disclosure or its application and uses. Furthermore, there is no intention to be bound by any expressed or implied theory presented in the preceding technical field, background, brief summary or the following detailed description.

Various embodiments of the present disclosure provide input devices, processing systems and methods for touch sensing and force sensing utilizing combination sensor conductors. The combination sensor conductors are configurable between states that function as capacitive sensor conductors and force sensor conductors. The state of the combination sensor conductors is configurable between capacitive sensor conductors and force sensor conductors via operation of a processing system. The ability of the combination sensor conductors to switch between capacitive and force sensing functions allows the input device embodying the combination sensor conductors to perform both capacitive touch and input force sensing without adding additional dedicated force sensor electrodes, thereby enhancing the functionality of the input device without the associated cost and undesirable additional thickness required by dedicated force sensor electrodes as used in conventional devices. As utilized herein, capacitive sensing is described as a touch sensing technique utilizing information received from capacitive sensor conductors at least some of which are combination sensor conductors, while force sensing is described as utilizing information received from force sensor conductors included in the combination sensor conductors to determine force that an input object exerts against the input device. Generally, each combination sensor conductor includes at least one capacitive sensor conductor and at least one force sensor conductor that share a same conductive portion.

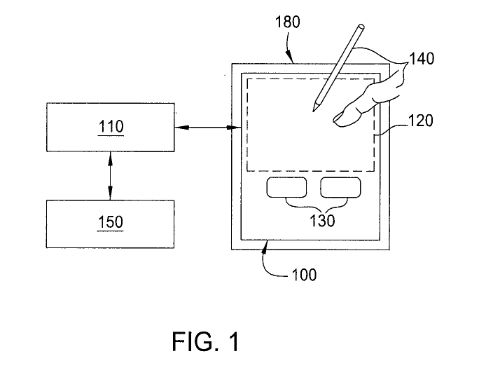

Turning now to the figures, FIG. 1 is a block diagram of an exemplary input device 100, in accordance with embodiments of the invention. The input device 100 may be configured to provide input to an electronic system 150. As used in this document, the term “electronic system” (or “electronic device”) broadly refers to any system capable of electronically processing information. Some non-limiting examples of electronic systems 150 include personal computers of all sizes and shapes, such as desktop computers, laptop computers, netbook computers, tablets, web browsers, e-book readers, and personal digital assistants (PDAs). Additional example electronic systems 150 include composite input devices, such as physical keyboards that include input device 100 and separate joysticks or key switches. Further example electronic systems 150 include peripherals such as data input devices (including remote controls and mice), and data output devices (including display screens and printers). Other examples include remote terminals, kiosks, and video game machines (e.g., video game consoles, portable gaming devices, and the like). Other examples include communication devices (including cellular phones, such as smart phones), and media devices (including recorders, editors, and players such as televisions, set-top boxes, music players, digital photo frames, and digital cameras). Additionally, the electronic system 150 could be a host or a slave to the input device.

The input device 100 can be implemented as a physical part of the electronic system 150, or can be physically separate from the electronic system 150. As appropriate, the input device 100 may communicate with parts of the electronic system 150 using any one or more of the following: buses, networks, and other wired or wireless interconnections. Examples include I²C, SPI, PS/2, Universal Serial Bus (USB), Bluetooth, RF, and IRDA.

In FIG. 1, the input device 100 is shown as a proximity sensor device (also often referred to as a “touchpad” or a “touch sensor device”) configured to sense input provided by one or more input objects 140 in a sensing region 120. Example input objects include fingers and styli, as shown in FIG. 1.

Sensing region 120 encompasses any space above, around, in and/or near the input device 100 in which the input device 100 is able to detect user input (e.g., user input provided by one or more input objects 140). The sizes, shapes, and locations of particular sensing regions may vary widely from embodiment to embodiment. In some embodiments, the sensing region 120 extends from a surface of the input device 100 in one or more directions into space until signal-to-noise ratios prevent sufficiently accurate object detection. The distance to which this sensing region 120 extends in a particular direction, in various embodiments, may be on the order of less than a millimeter, millimeters, centimeters, or more, and may vary significantly with the type of sensing technology used and the accuracy desired. Thus, some embodiments sense input that comprises no contact with any surfaces of the input device 100, contact with an input surface (e.g., a touch surface) of the input device 100, contact with an input surface of the input device 100 coupled with some amount of applied force or pressure, and/or a combination thereof. In various embodiments, input surfaces may be provided by surfaces of casings within which the sensor conductors reside, by face sheets applied over the sensor conductors or any casings, etc. In some embodiments, the sensing region 120 has a rectangular shape when projected onto an input surface of the input device 100.

The input device 100 may utilize any combination of sensor components and sensing technologies to detect user input in the sensing region 120. The input device 100 comprises one or more sensing elements for detecting user input. As several non-limiting examples, the input device 100 may use capacitive, elastive, resistive, inductive, magnetic, acoustic, ultrasonic, and/or optical techniques.

Some implementations are configured to provide images that span one, two, three, or higher dimensional spaces. Some implementations are configured to provide projections of input along particular axes or planes.

In some capacitive implementations of the input device 100, voltage or current is applied to create an electric field. Nearby input objects cause changes in the electric field, and produce detectable changes in capacitive coupling that may be detected as changes in voltage, current, or the like.

Some capacitive implementations utilize arrays or other regular or irregular patterns of capacitive sensing elements to create electric fields. In some capacitive implementations, separate sensing elements may be ohmically shorted together to form larger sensor conductors. Some capacitive implementations utilize resistive sheets, which may be uniformly resistive.

Some capacitive implementations utilize “self capacitance” (or “absolute capacitance”) sensing methods based on changes in the capacitive coupling between sensor conductors and an input object. In various embodiments, an input object near the sensor conductors alters the electric field near the sensor conductors, thus changing the measured capacitive coupling. In one implementation, an absolute capacitance sensing method operates by modulating sensor conductors with respect to a reference voltage (e.g., system ground), and by detecting the capacitive coupling between the sensor conductors and input objects.

Some capacitive implementations utilize “mutual capacitance” (or “transcapacitance”) sensing methods based on changes in the capacitive coupling between sensor conductors. In various embodiments, an input object near the sensor conductors alters the electric field between the sensor conductors, thus changing the measured capacitive coupling. In one implementation, a transcapacitive sensing method operates by detecting the capacitive coupling between one or more transmitter sensor conductors (also “transmitter conductors” or “transmitters”) and one or more receiver sensor conductors (also “receiver conductors” or “receivers”). Transmitter sensor conductors may be modulated relative to a reference voltage (e.g., system ground) to transmit transmitter signals. Receiver sensor conductors may be held substantially constant relative to the reference voltage to facilitate receipt of resulting signals. A resulting signal may comprise effect(s) corresponding to one or more transmitter signals, and/or to one or more sources of environmental interference (e.g., other electromagnetic signals). Capacitive sensor conductors may be dedicated transmitters or receivers, or may be configured to both transmit and receive.

In FIG. 1, a processing system 110 is shown as part of the input device 100. The processing system 110 is configured to operate the hardware of the input device 100 to detect input in the sensing region 120. The processing system 110 comprises parts of or all of one or more integrated circuits (ICs) and/or other circuitry components. For example, a processing system for a mutual capacitance sensor device may comprise transmitter circuitry configured to transmit signals with transmitter sensor conductors, and/or receiver circuitry configured to receive signals with receiver sensor conductors). In some embodiments, the processing system 110 also comprises electronically-readable instructions, such as firmware code, software code, and/or the like. In some embodiments, components composing the processing system 110 are located together, such as near sensing element(s) of the input device 100. In other embodiments, components of processing system 110 are physically separate with one or more components close to sensing element(s) of input device 100, and one or more components elsewhere. For example, the input device 100 may be a peripheral coupled to a desktop computer, and the processing system 110 may comprise software configured to run on a central processing unit of the desktop computer and one or more ICs (perhaps with associated firmware) separate from the central processing unit. As another example, the input device 100 may be physically integrated in a phone, and the processing system 110 may comprise circuits and firmware that are part of a main processor of the phone. In some embodiments, the processing system 110 is dedicated to implementing the input device 100. In other embodiments, the processing system 110 also performs other functions, such as operating display screens, driving haptic actuators, etc.

The processing system 110 may be implemented as a set of modules that handle different functions of the processing system 110. Each module may comprise circuitry that is a part of the processing system 110, firmware, software, or a combination thereof. In various embodiments, different combinations of modules may be used. Example modules include hardware operation modules for operating hardware such as sensor conductors and display screens, data processing modules for processing data such as sensor signals and positional information, and reporting modules for reporting information. Further example modules include sensor operation modules configured to operate sensing element(s) to detect input, identification modules configured to identify gestures such as mode changing gestures, and mode changing modules for changing operation modes.

In some embodiments, the processing system 110 responds to user input (or lack of user input) in the sensing region 120 directly by causing one or more actions. Example actions include changing operation modes (e.g., full touch report rate mode, low display power mode, high interference mode, low touch power mode, etc.), as well as GUI actions such as cursor movement, selection, menu navigation, and other functions. In some embodiments, the processing system 110 provides information about the input (or lack of input) to some part of the electronic system 150 (e.g., to a central processing system of the electronic system that is separate from the processing system 110, if such a separate central processing system exists). In some embodiments, some part of the electronic system 150 processes information received from the processing system 110 to act on user input, such as to facilitate a full range of actions, including mode changing actions and GUI actions.

For example, in some embodiments, the processing system 110 operates the sensing element(s) of the input device 100 to produce electrical signals indicative of input (or lack of input) in the sensing region 120. The processing system 110 may perform any appropriate amount of processing on the electrical signals in producing the information provided to the electronic system 150. For example, the processing system 110 may digitize analog electrical signals obtained from the sensor conductors. As another example, the processing system 110 may perform filtering or other signal conditioning. As yet another example, the processing system 110 may subtract or otherwise account for a baseline, such that the information reflects a difference between the electrical signals and the baseline. As yet further examples, the processing system 110 may determine positional information, recognize inputs as commands, recognize handwriting, and the like.

“Positional information” as used herein broadly encompasses absolute position, relative position, velocity, acceleration, and other types of spatial information. Exemplary “zero-dimensional” positional information includes near/far or contact/no contact information. Exemplary “one-dimensional” positional information includes positions along an axis. Exemplary “two-dimensional” positional information includes motions in a plane. Exemplary “three-dimensional” positional information includes instantaneous or average velocities in space. Further examples include other representations of spatial information. Historical data regarding one or more types of positional information may also be determined and/or stored, including, for example, historical data that tracks position, motion, or instantaneous velocity over time.

In some embodiments, the input device 100 is implemented with additional input components that are operated by the processing system 110 or by some other processing system. These additional input components may provide redundant functionality for input in the sensing region 120, or some other functionality. FIG. 1 shows buttons 130 near the sensing region 120 that can be used to facilitate selection of items using the input device 100. Other types of additional input components include sliders, balls, wheels, switches, and the like. Conversely, in some embodiments, the input device 100 may be implemented with no other input components.

In some embodiments, the input device 100 comprises a touch screen interface, and the sensing region 120 overlaps at least part of an active area of a display screen of a display 180. For example, the input device 100 may comprise substantially transparent sensor conductors overlaying the display screen of the display 180 and provide a touch screen interface for the associated electronic system 150 while still enabling images to be displayed through the display screen. The display screen may be any type of dynamic display capable of displaying a visual interface to a user, and may include any type of light emitting diode (LED), organic LED (OLED), cathode ray tube (CRT), liquid crystal display (LCD), plasma, electroluminescence (EL), or other display technology. The input device 100 and the display screen may share physical elements. For example, some embodiments may utilize some of the same electrical components for displaying and sensing (e.g., an Active Matrix of Thin Film a-Si transistors for AMOLED and AMLCD, etc.). As another example, the display screen of the display 180 may be operated in part or in total by the processing system 110.

It should be understood that while many embodiments of the invention are described in the context of a fully functioning apparatus, the mechanisms of the present invention are capable of being distributed as a program product (e.g., software) in a variety of forms. For example, the mechanisms of the present invention may be implemented and distributed as a software program on information bearing media that are readable by electronic processors (e.g., non- transitory computer-readable and/or recordable/writable information bearing media readable by the processing system 110). Additionally, the embodiments of the present invention apply equally regardless of the particular type of medium used to carry out the distribution. Examples of non-transitory, electronically readable media include various discs, memory sticks, memory cards, memory modules, and the like. Electronically readable media may be based on flash, optical, magnetic, holographic, or any other storage technology.

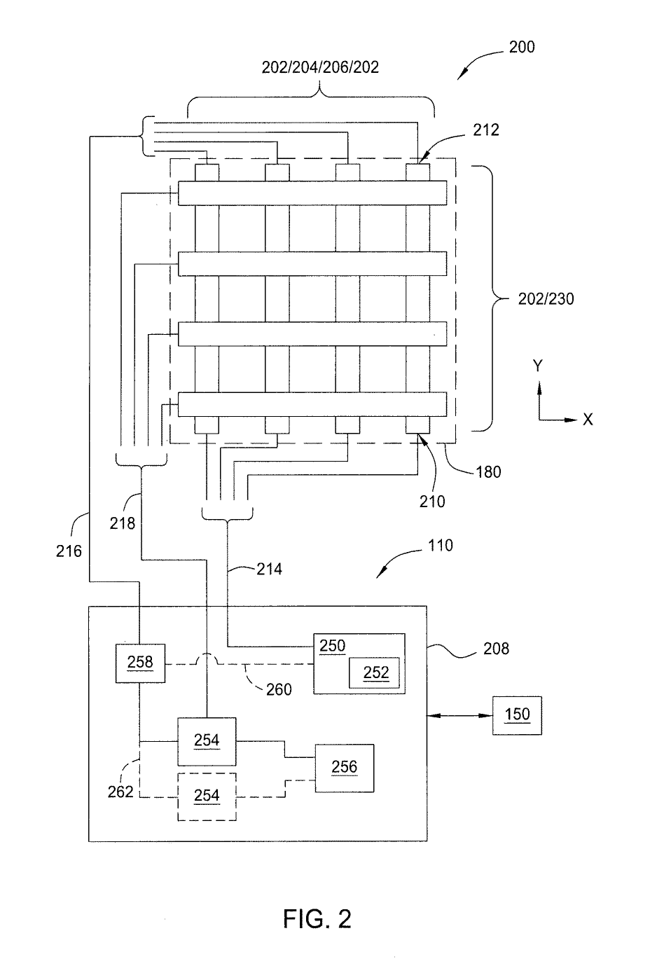

FIG. 2 illustrates a portion of an exemplary pattern of sensing elements according to some embodiments. For clarity of illustration and description, FIG. 2 shows the sensing elements in a pattern of simple rectangles and does not show various components, such as all the various interconnects between the sensing elements and the processing system 110. The sensing elements disposed below the sensing region 120 may be arranged in a pattern of input sensor conductors 200. The pattern of input sensor conductors 200 comprises a plurality of capacitive sensor conductors 202 and a plurality of combination sensor conductors 204. Some of the combination sensor conductors 204 may comprise some of the capacitive sensor conductors 202. For example, the combination sensor conductors 204 are configurable to function either as capacitive sensor conductors 202 or as force sensor conductors 206 via operation of the processing system 110 as further described below. Generally, each combination sensor conductor 204 includes at least one of the capacitive sensor conductors 202 and at least one of the force sensor conductors 206 that share a same conductive portion. The force sensor conductors 206 are arranged to provide a metric, such as resistance, that is indicative of a force applied to the sensing region 120 by an input object 140. The combination sensor conductors 204 may be operated in a first mode for capacitive sensing. When operating in the first mode, some or all of the combination sensor conductors 204 are operated as capacitive sensor conductors 202. The combination sensor conductors 204 may also be operated in a second mode for force sensing. When operating in the second mode, some or all of the combination sensor conductors 204 are operated as force sensor conductors 206.

In the example depicted in FIG. 2, the capacitive sensor conductors 202 include a first plurality of capacitive sensor conductors 220 and a second plurality of capacitive sensor conductors 230. The capacitive sensor conductors 230 may be disposed orthogonally over the first plurality of capacitive sensor conductors 220. It is contemplated that the pattern of input sensor conductors 200 may be configured with capacitive sensor conductors 220, 230 arranged in other suitable patterns. Further, the shape of capacitive sensor conductors 230 may not be constrained to rectangular dimension, and may be tessellated or approximately space filling repeating array structure. In various embodiments, the first plurality of capacitive sensor conductors 220 are operated in a first mode as a plurality of transmitter conductors (referred to specifically as “transmitter conductors 220”), and the second plurality of capacitive sensor conductors 230 are operated as a plurality of receiver conductors (referred to specifically as “receiver conductors 230”). In another embodiment, one plurality of capacitive sensor conductors may be configured to transmit and receive and the other plurality of capacitive sensor conductors may also be configured to transmit and receive when operating in the first mode, for example to perform absolute sensing. Further processing system 110 receives resulting signals with one or more capacitive sensor conductors of the first and/or second plurality of capacitive sensor conductors while the one or more capacitive sensor conductors are modulated with absolute capacitive sensing signals. The first plurality of capacitive sensor conductors 220, the second plurality of capacitive sensor conductors 230, or both can be disposed within the sensing region 120. The capacitive sensor conductors 220, 230 of the pattern of input sensor conductors 200 can be coupled to the processing system 110.

The first plurality of capacitive sensor conductors 220 and the second plurality of capacitive sensor conductors 230 are typically ohmically isolated from each other. That is, one or more insulators separate the first plurality of capacitive sensor conductors 220 and the second plurality of capacitive sensor conductors 230 and prevent them from electrically shorting to each other. In some embodiments, the first plurality of capacitive sensor conductors 220 and the second plurality of capacitive sensor conductors 230 are separated by insulative material disposed between them at cross-over areas; in such constructions, the first plurality of capacitive sensor conductors 220 and/or the second plurality of capacitive sensor conductors 230 can be formed with jumpers and/or vias connecting different portions of the same sensor conductors. In some embodiments, the first plurality of capacitive sensor conductors 220 and the second plurality of capacitive sensor conductors 230 are separated by one or more layers of insulative material. In such embodiments, the first plurality of capacitive sensor conductors 220 and the second plurality of capacitive sensor conductors 230 can be disposed on separate layers of a common substrate. In some other embodiments, the first plurality of capacitive sensor conductors 220 and the second plurality of capacitive sensor conductors 230 are separated by one or more substrates; for example, the first plurality of capacitive sensor conductors 220 and the second plurality of capacitive sensor conductors 230 can be disposed on opposite sides of the same substrate, or on different substrates that are laminated together. In some embodiments, the first plurality of capacitive sensor conductors 220 and the second plurality of capacitive sensor conductors 230 can be disposed on the same side of a single substrate.

The areas of localized capacitive coupling between the first plurality of capacitive sensor conductors 220 and the second plurality capacitive sensor conductors 230 may be form “capacitive pixels” of a “capacitive image.” The capacitive coupling between capacitive sensor conductors of the first and second pluralities of capacitive sensor conductors 220 and 230 changes with the proximity and motion of input objects in the sensing region 120. Further, in various embodiments, the localized capacitive coupling between each of the first plurality of capacitive sensor conductors 220 and the second plurality, of capacitive sensor conductors 230 and an input object may be termed “capacitive pixels” of a “capacitive image” (e.g., as part of a sensing measurement image frame, etc.). In some embodiments, the localized capacitive coupling between each of the first plurality of capacitive sensor conductors 220 and the second plurality of capacitive sensor conductors 230 and an input object may be termed “capacitive measurements” of “capacitive profiles” (e.g., where a profile may be a linear projection of an array of conductors, etc.).

The processing system 110 can include a sensor module 208 having sensor circuitry. The components of the sensor module 208 may be embodied in one or more integrated circuit chips.

The sensor module 208 may include a driver module 250, and one or more source drivers (e.g., Chip On Glass COG or Chip On Flex COF ASICs, etc.) 252. The driver module 250 uses the sensor circuitry to operate the sensor pattern of input sensor conductors 200 to receive resulting signals from capacitive sensor conductors 202 in the sensor conductor pattern using a capacitive sensing signal having a sensing frequency (e.g., a square wave, sine wave or other narrow band carrier, etc.) when operating in the first mode. Processing system 110 may also comprise one or more multiplexers coupled to capacitive sensor conductors 220, 230. One or more sensor conductor from capacitive sensor conductors 220 or 230 may be coupled to each multiplexer, where a multiplexer couples one or more sensor conductors to the sensing circuitry and the source driver 252. Further, a multiplexer may be disposed within sensor module 208 or external to sensor module 208. The processing system 110 may comprise a timing controller, synchronization module and a gate control module (not shown). The gate control module provides gate clocking and configuration signals (e.g., Clock1, Clock2, Clock3, Clock4, reset, start pulse, direction, output enable, gate voltage control, etc.) in the proper sequence for each line (e.g., first line of display frame, last line of display frame, vertical blank time, display line to non-display line transition, non-display line to display line transition, display line to display line transition, and non-display line to non-display line transition, repeated same line, etc.) to the gate logic (e.g., COG—Gate IC or TFT—Gate in Panel) during the frame controlled by the timing controller and/or synchronization module.

The sensor module 208 may also include a receiver module 254. The receiver module 254 uses the sensor circuitry to operate the sensor pattern of input sensor conductors 200 to receive resulting signals from capacitive sensor conductors 202 in the sensor conductor pattern. The sensor circuitry of the receiver module 254 may comprise a plurality of analog front ends (AFEs). The analog front end may comprise an integrator and other circuitry configured to integrate the amount of charge driven onto the capacitive sensor conductor 202. The analog measurement is typically converted into digital data by an Analog to Digital Converter (e.g., Successive Approximation ADC, Sigma Delta ADC or other ADC, etc.) so that digital processing may take place in a determination module 256.

The determination module 256 may be part of the sensor module 208, or may be remotely interfaced thereto as part of the electronic system 150. The determination module 256 includes firmware and/or circuitry, and is configured to determine capacitive measurements from the resulting signals. The determination module 256 can track changes in capacitive measurements to detect input object(s) in the sensing region 120, from the changes in capacitive measurements, and provide a signal indicative of the location of the input object(s) in the sensing region 120.

The processing system 110 can include other modular configurations, and the functions performed by the sensor module 208 can, in general, be performed by one or more modules in the processing system 110. The processing system 110 can include modules, and can perform other functions as described in some embodiments below.

As discussed above, the sensor module 208 of the processing system 110 can operate in a first mode for capacitive sensing and in a second mode for force sensing. The first mode for capacitive sensing may be further operated in an absolute capacitive sensing mode or a transcapacitive sensing mode. In an absolute capacitive sensing mode, receiver(s) in the sensor circuitry of the receiver module 254 measure voltage, current, or charge on sensor conductor(s) in the pattern of input sensor conductors 200 while the sensor conductor(s) are modulated by the driver module 250 with absolute capacitive sensing signals to generate the resulting signals. The determination module 256 generates absolute capacitive measurements from the resulting signals. The determination module 256 can track changes in absolute capacitive measurements to detect input object(s) in the sensing region 120.

In a transcapacitive sensing mode, source drivers 252 in the sensor circuitry of the driver module 250 drive one or more of the first plurality of capacitive sensor conductors 220 with the capacitive sensing signal (also referred to as a transmitter signal or modulated signal in the transcapacitive sensing mode). Receiver(s) in the sensor circuitry of the receiver module 254 measure voltage, current, or charge on one or more of the second plurality of capacitive sensor conductors 230 to generate the resulting signals. The resulting signals comprise the effects of the capacitive sensing signal and input object(s) in the sensing region 120. The determination module 256 generates transcapacitive measurements from the resulting signals. The determination module 256 can track changes in transcapacitive measurements to detect input object(s) in the sensing region 120. In various embodiments, one or more conductors may be modulated with a shield signal to reduce extraneous charge coupling between conductors. These conductors may be other sensor conductors, display conductors or any other electrode in input device 100. Further, a modulated shield signal may be referred to as a guard signal and may have at least one of an amplitude, frequency and/or phase in common with the sensing signal driven onto the sensor conductor.

In the second mode of operation set by the processing system 110, the combination sensor conductors 204 are set to function as the force sensor conductors 206. In the second mode, the driver module 250 is coupled to the first end 210 of the force sensor conductors 206 and drives a signal on selected one or more of force sensor conductors 206. The signal driven onto the force sensor conductors 206 may be a square wave, sine wave or other wave form. The second end 212 of the force sensor conductors 206 is coupled to the receiver module 254. The receiver module 254 measures the resistance on the force sensor conductors 206 to obtain values indicative of force applied to the input object 140 by an input object 140.

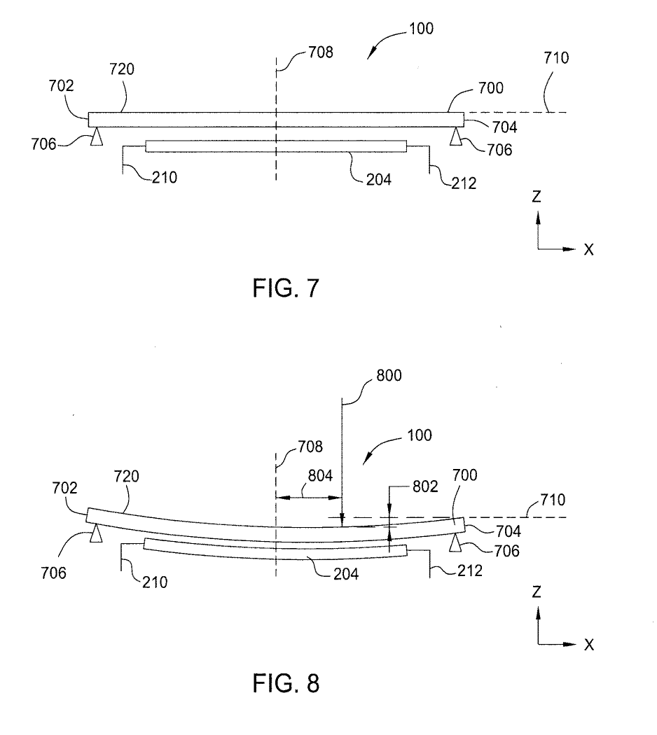

In one example, the resistance is measured on the force sensor conductors 206 to obtain a change in resistance of the force sensor conductor 206 compared to a baseline resistance value stored in the memory of or accessible to the sensor module 208. The change in resistance is due to bending of the force sensor conductors 206 in response to the force applied by the input object 140 to an input surface of the input device 100. In another example, the resistance is measured at least twice on the same force sensor conductor 206 to obtain a change in resistance of the force sensor conductor 206 due to bending of the force sensor conductor 206 in response to the force applied by the input object 140 to the input surface of the input device 100. In yet another example, the resistance is measured at two spatially separated force sensor conductors 206 to obtain a change in resistance of one of the force sensor conductor 206 due to bending of the force sensor conductor 206 in response to the force applied by the input object 140 to the input surface of the input device 100. The spatially separated force sensor conductors 206 may optionally be in close proximity, however, utilizing one force sensor conductor 206 located near an edge of the input device 100 as a baseline for comparison to another force sensor conductor 206 located spatially inward of the end of the input device 100 (such as near the center) will provide more accurate force information. Additional information regarding forces sensing is described with reference to FIGS. 7-9 below.

Continuing to refer to FIG. 2, in some embodiments the processing system 110 “scans” the pattern of, input sensor conductors 200 to determine capacitive and resistive measurements respectively during the first and second operational modes (i.e., the capacitive sensing and force sensing modes). Each line scanned of the pattern of input sensor conductors 200 may be referred to as a sensing event. In the transcapacitive sensing mode, the driver module 250 of the processing system 110 can drive the first plurality of capacitive sensor conductors 220 to transmit transmitter signal(s). A line of the pattern of capacitive sensor conductors may refer to a grouping of capacitive sensor conductors. The line may be a row, column or any other grouping of capacitive sensor conductors. Line rate refers to the period utilized to update a line, either for display updating or for capacitive sensing. Multiplexers may be used to define the order in which the capacitive sensor conductors are scanned. The multiplexers may selectively configure which capacitive sensor conductor or capacitive sensor conductors are coupled to the sensing circuitry of the receiver module 254. The sensor circuitry, such as AFEs, may comprise an integrator and other circuitry configured to integrate the amount of charge driven onto the capacitive sensor conductor 202. From the amount of charge driven onto the capacitive sensor conductor 202, the sensor circuitry in the determination module 256 may determine a change in capacitance or resistance in accordance to the mode of operation. The driver module 250 of the processing system 110 can operate the first plurality of capacitive sensor conductors 220 such that one transmitter sensor conductor transmits at one time, or multiple transmitter sensor conductors transmit at the same time. Where multiple transmitter sensor conductors transmit simultaneously, these multiple transmitter sensor conductors may transmit the same transmitter signal and effectively produce a larger transmitter sensor conductor, or these multiple transmitter sensor conductors may transmit different transmitter signals. For example, multiple transmitter sensor conductors may transmit different transmitter signals according to one or more coding schemes that enable their combined effects on the resulting signals of the second plurality of capacitive sensor conductors 230 to be independently determined. In the absolute capacitive sensing mode, the receiver module 254 of the processing system 110 can receiving resulting signals from one capacitive sensor conductor 220, 230 at a time, or from a plurality of capacitive sensor conductors 220, 230 at a time. In either mode, the driver module 250 of the processing system 110 can operate the second plurality of capacitive sensor conductors 230 singly or collectively to acquire resulting signals. In absolute capacitive sensing mode, the driver module 250 of the processing system 110 can concurrently drive all capacitive sensor conductors along one or more axes. In some examples, the processing system 110 can drive capacitive sensor conductors along one axis (e.g., along the first plurality of capacitive sensor conductors 220) while capacitive sensor conductors along another axis are driven with a shield signal, guard signal, or the like. In some examples, some capacitive sensor conductors along one axis and some capacitive sensor conductors along the other axis can be driven concurrently. In the absolute capacitive sensing mode, the power supply of the source driver or power management integrated circuit (PMIC) may be isolated from system ground and modulated relative to system ground. The host display data interface may remain reference to system ground while the source driver processed display data and/or gate control signals are modulated relative to system ground.

In the transcapacitive sensing mode, the determination module 256 of the processing system 110 can use the resulting signals to determine capacitive measurements at the capacitive pixels. A set of measurements from the capacitive pixels form a “capacitive image” (also “capacitive frame”) representative of the capacitive measurements at the pixels. The determination module 256 of the processing system 110 can acquire multiple capacitive images over multiple time periods (i.e., sensing events), and can determine differences between capacitive images to derive information about input in the sensing region 120. For example, the determination module 256 of the processing system 110 can use successive capacitive images acquired over successive periods of time to track the motion(s) of one or more input objects entering, exiting, and within the sensing region 120.

In absolute capacitive sensing mode, the determination module 256 of the processing system 110 can use the resulting signals to determine capacitive measurements along an axis of the capacitive sensor conductors 220 and/or an axis of the capacitive sensor conductors 230 (e.g., along one or more columns or rows). A set of such measurements forms a “capacitive profile” representative of the capacitive measurements along the axis. The determination module 256 of the processing system 110 can acquire multiple capacitive profiles along one or both of the axes over multiple time periods and can determine differences between capacitive profiles to derive information about input in the sensing region 120. For example, the determination module 256 of the processing system 110 can use successive capacitive profiles acquired over successive periods of time to track location or proximity of input objects within the sensing region 120. In other embodiments, each capacitive sensor conductor can be a capacitive pixel of a capacitive image and the absolute capacitive sensing mode can be used to generate capacitive image(s) in addition to or in place of capacitive profiles.

The baseline capacitance of the input device 100 is the capacitive image or capacitive profile associated with no input object in the sensing region 120. The baseline capacitance changes with the environment and operating conditions, and the determination module 256 of the processing system 110 can estimate the baseline capacitance in various ways. For example, in some embodiments, the determination module 256 of the processing system 110 takes “baseline images” or “baseline profiles” when no input object is determined to be in the sensing region 120, and uses those baseline images or baseline profiles as estimates of baseline capacitances. The determination module 256 can account for the baseline capacitance in the capacitive measurements and thus the capacitive measurements can be referred to as “delta capacitive measurements”. Thus, the term “capacitive measurements” as used herein encompasses delta-measurements with respect to a determined baseline.

The time required to obtain a complete capacitive frame by scanning all the capacitive pixels across the sensing region 120 divided by the number of discreet capacitive scanning events defines the capacitive sensing frame rate. The capacitive sensing frame report rate is based on the duty cycle of the sensor module 208 and the duty cycle indicated by the host device of the electronic system 150 communicating with the input device 100. As discussed above, it is advantageous for the capacitive sensing frame rate to be maintained substantially constant, even when the display refresh rate and/or sensing frequency is changed. The methodology maintaining a fairly constant capacitive sensing frame rate is further detailed below.

In a force sensing mode, the determination module 256 of the processing system 110 can use the resulting signals to determine resistance measurements of the force sensor conductors 206. A set of such measurements forms a “restive profile” representative of the resistive measurements across the input surface of the input device 100. The determination module 256 of the processing system 110 can acquire multiple resistive profiles over multiple time periods and can determine differences between resistive profiles of the force sensor conductors 206 to derive information about force applied to the input surface of the sensing region 120. For example, the determination module 256 of the processing system 110 can use successive resistive profiles acquired over successive periods of time to track the amount of force applied by input objects to an input surface the sensing region 120.

The baseline resistance of each force sensor conductors 206 of the input device 100 is the resistive image or resistive profile associated with no input object in the sensing region 120. The baseline resistance may change with the environment and operating conditions, and the determination module 256 of the processing system 110 can estimate the baseline resistance in various ways. For example, in some embodiments, the determination module 256 of the processing system 110 takes “baseline images” or “baseline profiles” when no input object is determined to be in the sensing region 120, and uses those baseline images or baseline profiles as estimates of baseline resistance for each force sensor conductor or to generate a baseline or map across all the force sensor conductors. The determination module 256 can account for the baseline resistance in the resistive measurements and thus the resistive measurements can be referred to as “delta resistance measurements”. Thus, the term “resistive measurements” as used herein encompasses delta-measurements with respect to a determined baseline.

The time required to obtain a complete resistive frame by scanning all the force sensor conductors 206 across the sensing region 120 divided by the number of discreet resistive scanning events defines the resistive sensing frame rate. The resistive sensing frame report rate is based on the duty cycle of the sensor module 208 and the duty cycle indicated by the host device of the electronic system 150 communicating with the input device 100. It is advantageous for the resistive sensing frame rate to be maintained substantially equal to the capacitive frame rate since positional information may be utilized to enhance the determination of the force applied to the input device 100.

In some touch screen embodiments, at least one of the first plurality of capacitive sensor conductors 220 and the second plurality of capacitive sensor conductors 230 comprise one or more display conductors of the display 180 used in updating a display of a display screen, such as one or more segments of a “Vcom” electrode (common electrodes), gate electrodes, source electrodes, anode electrode and/or cathode electrode. The updating or refresh of each line of the panel of the display 180 may be referred to as a display line update event. These display conductors may be disposed on an appropriate display screen substrate. For example, the display conductors may be disposed on a transparent or flexible substrate (a glass substrate, TFT (e.g., amorphous silicon, indium gallium zinc oxide, low temperature polysilicon or other thin film transistor) glass, a polyimide flexible substrate, or any other transparent and/or flexible material) in some display screens (e.g., In Plane Switching (IPS), Fringe Field Switching (FFS) or Plane to Line Switching (PLS) Organic Light Emitting Diode (OLED)), on the bottom of the color filter glass of some display screens (e.g., Patterned Vertical Alignment (PVA) or Multi-domain Vertical Alignment (MVA)), over an emissive layer (OLED), etc. Conductive routing traces coupled to the sensor conductors may be disposed in a metal layer of the display stack-up while the sensor conductors may be disposed on a separate layer and be comprised of a transparent material (e.g., indium tin oxide, other metal oxides, etc.). Alternately, the sensor conductors may be entirely composed of opaque metallic materials (e.g., molybdenum, aluminum, titanium, etc.) The display conductors can also be referred to as “combination sensor conductors,” since the display conductors perform functions of display updating and capacitive sensing. In various embodiments, each sensor conductor of the first and second plurality of capacitive sensor conductors 220 and 230 comprises one or more combination sensor conductors. In other embodiments, at least two capacitive sensor conductors of the first plurality of capacitive sensor conductors 220 or at least two capacitive sensor conductors of the second plurality of capacitive sensor conductors 230 may share at least one combination electrode. Furthermore, in one embodiment, both the first plurality of capacitive sensor conductors 220 and the second plurality capacitive sensor conductors 230 are disposed within a display stack on the display screen substrate. Additionally, at least one of the capacitive sensor conductors 220, 230 in the display stack may comprise a combination electrode. However, in other embodiments, only the first plurality of capacitive sensor conductors 220 or the second plurality of capacitive sensor conductors 230 (but not both) are disposed within the display stack, while other capacitive sensor conductors are outside of the display stack (e.g., disposed on an opposite side of a color filter glass).

In an embodiment, the processing system 110 comprises a single integrated controller, such as an application specific integrated circuit (ASIC), having at least the driver module 250, the source drivers 252, the receiver module 254, and the determination module 256 formed on a single IC chip. In another embodiment, the processing system 110 can include a plurality of integrated circuit (IC) chips, where the driver module 250, the source drivers 252, and receiver module 254 (and optionally the determination module 256) can be divided among two or more IC chips. For example, at least the driver module 250 and receiver module 254 can be configured as one integrated circuit chip. In some embodiments, a first portion of the sensor module 208 can be on one integrated circuit and a second portion of the sensor module 208 can be on second integrated circuit. In such embodiments, at least one of the first and second integrated circuits comprises at least portions of other modules such as a touch driver module and/or a display (i.e., source) driver module. In various embodiments, where the processing system 110 comprises a plurality of integrated circuits comprising a timing controller (e.g., TCON IC) and source driver (e.g., COG) integrated circuits. The timing controller is typically configured receive display update data and sensing configuration data from a host device of the electronic system 150 communicating with the input device 100. Display data may also be internally generated by the driver module 250 to minimize latency between user input and user interface (UI) update, but typically this is an overlay (e.g., pop-up button, moving slider, cursor text selection, etc.) over host display images (e.g., rendered video, email application, web page, etc.). Overlay display image content (i.e., separate from the refresh rate) and driver module 250 display overlay response to user input (e.g., user touch input location or motion) may also be controlled by the electronic system 150. The timing control processes the received display update data and sensing configuration data and communicates the processed display data to each of the source driver integrated circuits. The TCON IC may contain a display data buffer (e.g., frame or line buffers) and may process (e.g., compress) and resynchronize the display data between the host and the source driver. The source driver integrated circuits comprise one or more source drivers, each coupled to and configured to drive a source line of the display device for display updating. Further, the source driver integrated circuit may comprise sensing circuit configured to modulate capacitive sensor conductors and/or receive resulting signals from the capacitive sensor conductor for capacitive sensing. The TCON IC, source driver IC or host may comprise the determination module 256 configured to process the resulting signals to determine positional information. The source driver integrated circuits may be configured to communicate raw sensing data, partially processed sensing data or positional information to the timing controller, for further processing or the timing controller may directly communicate this information to the host. In other embodiments, the timing control may be configured to process the sensing data received from the source driver integrated circuits to determine positional information for one or more input objects. In various embodiments each source driver integrated circuit may comprise one or more of plurality of digital-to-analog converters (DAC), gamma control, source buffer, Vcom reference, data receiver, buffer, modulator, AFEs, etc. The timing controller may comprise one or more of a frame buffer (full or partial), host data receiver, gate control, determination module etc. A separate die containing RAM (e.g., Static or Dynamic Random Access Memory) for the frame buffer may be stacked on the TCON either as a die (e.g., with wire bonds connecting them) or as a wafer (e.g., with through Silicon Vias connecting them). A power management integrated circuit (PMIC) may be coupled to at least one of the timing controller and each source driver integrated circuit and may configured to provide (e.g., generate from a another supply voltage by inductive or capacitive boost circuits, etc.) a high gate voltage, low gate voltage, Vcom voltage, display voltage supply modulation, etc.

The sensor module 208 is coupled by routing to the input sensor conductors 200 of the input device 100. For example, the receiver sensor conductors 220 comprising the capacitive sensor conductors 202 may be coupled by routing 218 to the receiver channel of the receiver module 254, while first ends 210 of the combination sensor conductors 204 are coupled by routing 214 to the transmitter channel of the sensor module 208. Second ends 212 of the combination sensor conductors 204 are coupled by routing 216 to the transmitter channel of the sensor module 208 through a switch 258.

The switch 258 has at least two states. While the processing system 110 is operating in the first mode for capacitive sensing, the switch 258 is set to a first state. In the first state, the switch 258 does not couple the second ends 212 of the combination sensor conductor 204 to another circuit or ground, i.e., the routing 216 is in an open circuit state. Alternatively, while the processing system 110 is operating in the first mode, the first state of the switch 258 couples the second ends 212 of the combination sensor conductor 204 to the driver module 250. Thus, while the switch 258 is in the first state, the combination sensor conductor 204 is configured for capacitive sensing, and thus the combination sensor conductor 204 is configured as one of the capacitive sensor conductors 202.

The switch 258 is set to the second state when the processing system 110 is operating in the second mode for force sensing. The switch 258, while in the second state, couples the routing 216 connected to the second ends 212 of the combination sensor conductor 204 to the receiver module 254. The receiver module 254 connected to the switch 258 may be the same receiver module 254 coupled to the receiver conductors 230, or may be connected by routing 262 to a separate receiver module 254 primarily purposed for force sensing as shown in phantom. While in the second state, the switch 258 enables the combination sensor conductor 204 to be configured for force sensing, thus configuring combination sensor conductors 204 as one of the force sensor conductors 206.

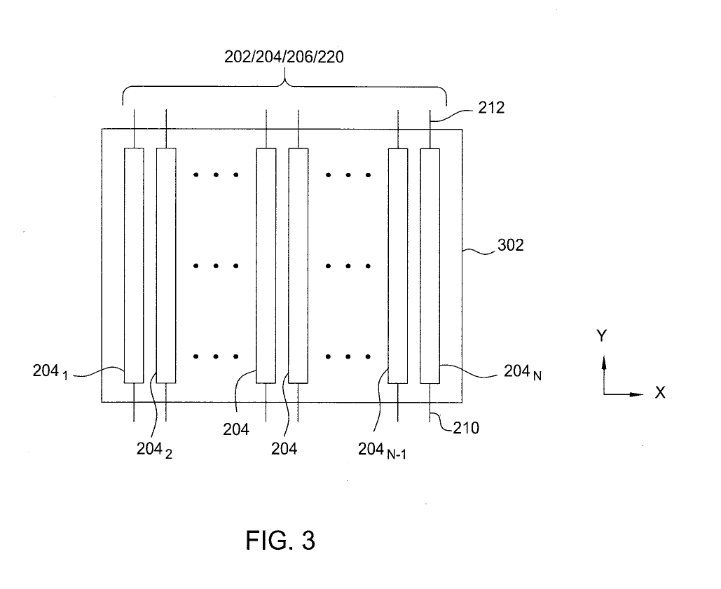

FIG. 3 is a partial illustration of the input device 100 showing an exemplary configuration of combination sensor conductors 204 that may be utilized in the input device 100 described above, according to some embodiments. As illustrated in FIG. 3, the combination sensor conductors 204 are arranged in a plurality of columns. The numbers of columns may be selected to provide a desired electrode pitch and performance, among other factors. In the example of FIG. 3, the combination sensor conductors 204 are shown disposed on a substrate 302. Combination sensor conductor 204₁ is disposed at a first edge of the substrate 302, with additional combination sensor conductors 204ᵢ extending in a one dimensional (e.g., 1 row) array across the substrate 304. The last combination sensor conductors 204_{N} in the array is disposed proximate the second edge of the substrate 302, the second edge disposed on an opposite side of the substrate 302 relative to the first edge. In the illustration of FIG. 3, N is a positive integer less than or equal to a maximum number of combination sensor conductors 204 that can fit on the substrate 302, where i is an integer in the range of 2 to N−1). Each combination sensor conductors 204 is associated with a position within the input device 100, for example in the depiction of FIG. 3, with a particular coordinate of the input device 100 in the X-direction.

The geometric layout of the combination sensor conductors 204 in columns within the coordinate system of the input device 100 allow each combination sensor conductor 204 to be scanned in the X-direction while functioning as one of the capacitive sensor conductors 202, or to be scanned in the X-direction while functioning as one of the force sensor conductors 206. As further discussed below, two or more of the force sensor conductors 206 may be coupled together at their first and second ends 210, 212, for example through multiplexing, switching and the like, to form a larger force sensor conductor to improve measurement resolution, as further discussed below.

In one example, the force sensor conductors 206 may be substantially equal in length. Having the force sensor conductors 206 be substantially equal in length reduces complexity, particularly when comparing the resistance of one force sensor conductor 206 to another.

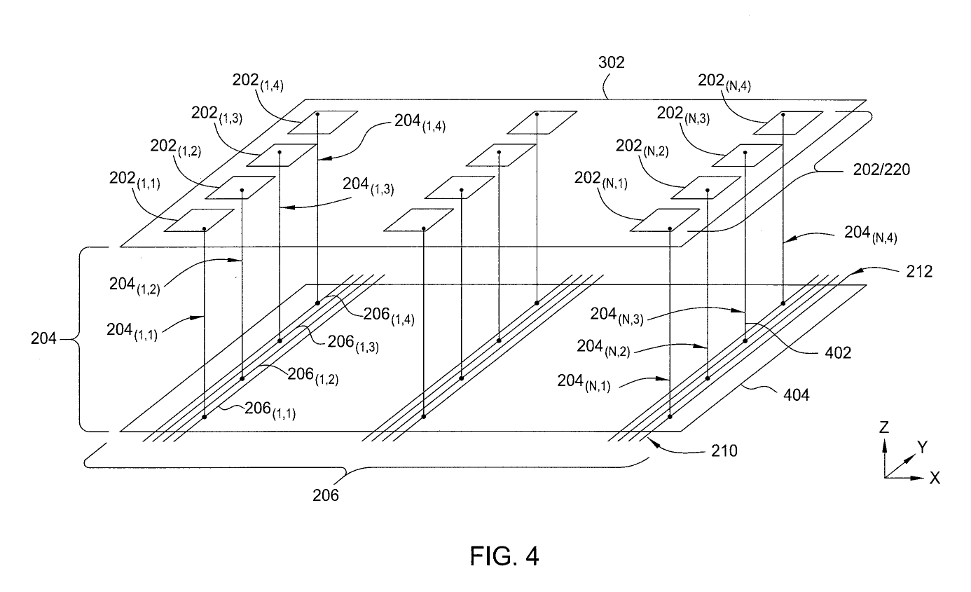

FIG. 4 is a partial illustration of the input device 100 showing another exemplary configuration of combination sensor conductors 204 that may be utilized in the input device 100 described above according to some embodiments. For clarity of illustration and description, FIG. 4 presents each combination sensor conductor 204 as a capacitive sensor conductor 202 coupled by a via 402 to a force sensor conductor 206. The force sensor conductor 206 is in the form of a conductive routing trace extending across a substrate 404 disposed below the substrate 302 on which the capacitive sensor conductors 202 are formed. Thus, the force sensor conductor 206 generally extends across the input surface of the input device 100. The first end 210 of the force sensor conductor 206 is disposed at one edge of the substrate 404, while the second end 212 of the force sensor conductor 206 is disposed at an opposite edge of the substrate 404. Alternatively, the force sensor conductor 206 may be disposed on the opposite side of the substrate 302 on which the capacitive sensor conductors 202 are formed.

The capacitive sensor conductors 202 are arranged in a pattern across the substrate 404. The capacitive sensor conductors 202 illustrated in FIG. 4 are disposed in a rectangular matrix (i.e., Cartesian rectangular array), or other suitable tessellated or approximately space filling repeating array structure. The pattern of capacitive sensor conductors 202 comprises capacitive sensor conductors 202_{M,N} (referred to collectively as capacitive sensor conductors 202) arranged in M rows and N columns, where M and N are a positive integers. Although FIG. 4 illustrates M equaling 4 rows of capacitive sensor conductors 202, other amounts of capacitive sensor conductor rows may be utilized. It is contemplated that the pattern of input sensor conductors 200 may comprise other patterns of the capacitive sensor conductors 202, such as polar arrays, repeating patterns, non-repeating patterns, non-uniform arrays a single row or column, or other suitable arrangement. Further, the capacitive sensor conductors 202 may be any shape, such as circular, rectangular, diamond, star, square, noncovex, convex, nonconcave concave, interdigitated, interlocking, etc. Further, the capacitive sensor conductors 202 may be sub-divided into a plurality of distinct sub-conductors. The pattern of capacitive sensor conductors 202 is coupled to the processing system 110 the conductive routing disposed on the substrate 404, that then the processing system 110 is operating in the second force sensing mode, the conductive routing is utilized as the force sensor conductor 206.

The capacitive sensor conductors 202 are typically ohmically isolated from one another. Additionally, where a capacitive sensor conductors 202 includes multiple sub-conductors, the sub-conductors may be ohmically isolated from each other. Furthermore, in one embodiment, the capacitive sensor conductors 202 may be ohmically isolated from an optional grid electrode (not shown) that is between the capacitive sensor conductors 202 on the same substrate 302. The grid electrode may be used as a shield or to carry a guarding signal for use when performing capacitive sensing with the capacitive sensor conductors 202.

As discussed above, the first mode of operation may perform absolute or transcapacitive techniques. For example, the processing system 110 can use at least one capacitive sensor conductor 202 to detect the presence of an input object via absolute capacitive sensing. The sensor module 208 can measure voltage, charge, or current on capacitive sensor conductor(s) 202 to obtain resulting signals indicative of a capacitance between the capacitive sensor conductor(s) 202 and an input object 140. The determination module 256 uses the resulting signals obtained by the receiver module 254 to determine absolute capacitive measurements. When the pattern of capacitive sensor conductors 202 of the input sensor conductors 200 is arranged in a matrix array, the absolute capacitive measurements can be used to form capacitive images.

In another example, the processing system 110 can use groups of capacitive sensor conductors 202 to detect the presence of an input object via transcapacitive sensing. The driver module 250 of the sensor module 208 can drive at least one of the capacitive sensor conductors 202 (or grid electrode) with a transmitter signal, and can receive a resulting signal from at least one other of the capacitive sensor conductors 202. The determination module 256 uses the resulting signals obtained by the receiver module 254 to determine absolute capacitive measurements and form capacitive images (or profiles, etc.).

As illustrated in FIG. 4, the first and second ends 210, 212 of the force sensor conductors 206 are coupled to the sensor module 208. The force sensor conductors 206 are arranged in columns across the width of the substrate 404. The force sensor conductors 206 associated with a column of capacitive sensor conductors 202 are arranged in a group, and can be positionally designed as force sensor conductors 206_{(M, N)}, where M and N are a positive integers, and M indicating the number of capacitive sensor conductors 202 in a particular column. It is contemplated that other number of columns of force sensor conductors 206 may be utilized as desired within the bounds of the space available on the substrate 404.

As discussed above, the combination sensor conductors 204_{(M, N)} may be set to function as force sensor conductors 206_{(M, N)} when the processing system 110 is operating in the second mode. In the second mode, the transmitter channel of the driver module 250 is coupled to the first end 210 of the force sensor conductors 206 drives a signal on selected one or more of force sensor conductors 206_{(M, N)}. The second end 212 of the force sensor conductors 206_{(M, N)} is coupled to the receiver channel of the receiver module 254. The receiver module 254 can measure resistance on the force sensor conductors 206_{(M, N)} to obtain value indicative of force applied to the input object 140 by an input object 140. The determination module 256 uses the value indicative of force obtained by the receiver module 254 to determine force applied to the input device 100.

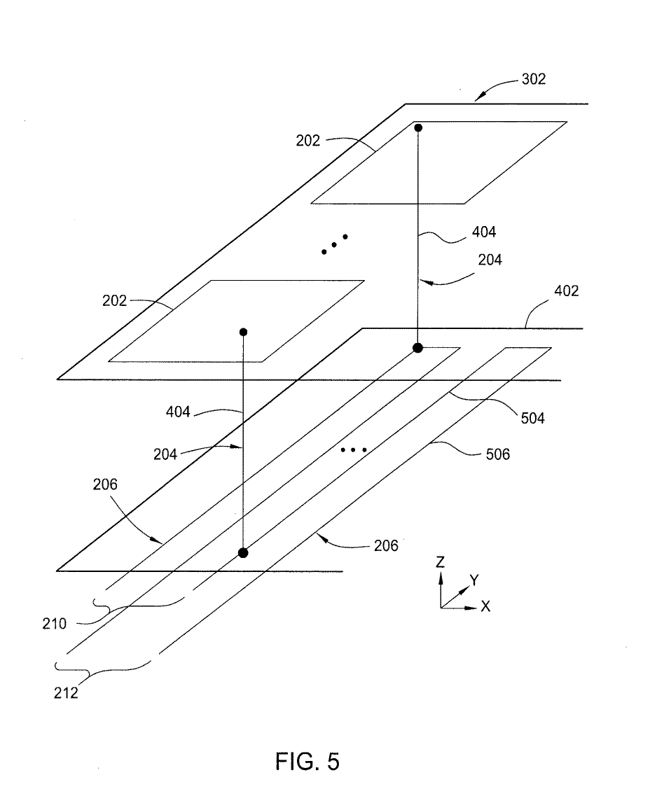

FIG. 5 is a partial illustration of the input device 100 showing yet another exemplary configuration of combination sensor conductors 204 that may be utilized in the input device 100 described above according to some embodiments. In the embodiment depicted in FIG. 5, the routing trace comprising each force sensor conductor 206_{(M, N)} includes a first section 504 coupled to a second section 506 in an elongated U-shaped configuration. Each of the sections 504, 506 extends essentially completely across the substrate 402, thus allowing the ends 210, 212 of each force sensor conductor 206_{(M, N)} to be disposed on the same side of the substrate 402, which advantageously simplifies routing to the sensor module 208. Additionally, having two sections 504, 506 extending across the substrate 402 increases the resistance of the each force sensor conductor 206_{(M, N)}, which can be useful in bringing the sensing circuit into a more suitable range for measuring resistance for a particular configuration when the force sensor conductor 206_{(M, N)} changes resistance due to stretching as substrate 402 of the input device 100 is deflected due to a force applied to the surface of the input device 100 by an input object.

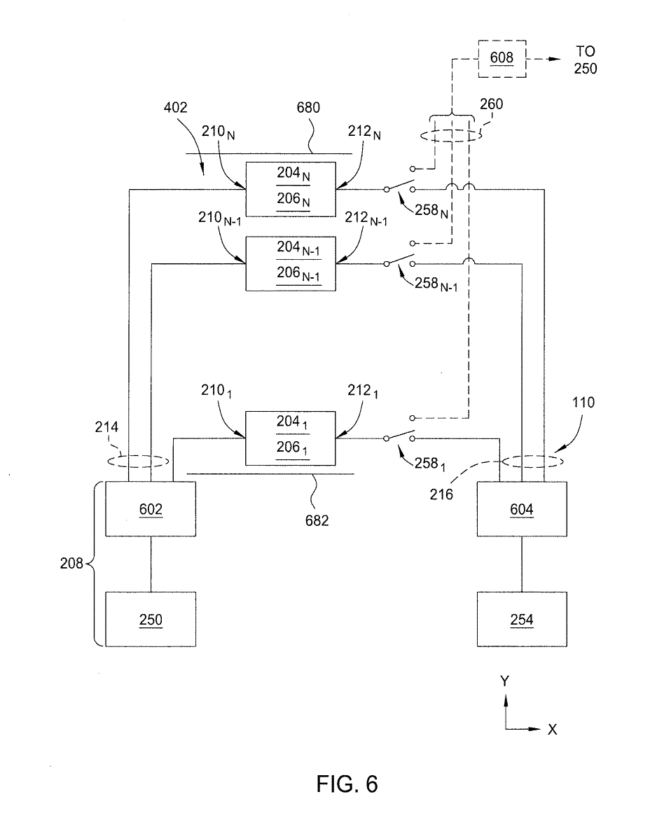

FIG. 6 is a schematic block circuit diagram of an exemplary configuration of combination sensor conductors 204 coupled to the processing system 110 that may be utilized in an input device 100 according to some embodiments. The configuration of the force sensor conductors 206 included in the combination sensor conductors 204 is essentially identical to those described in FIGS. 2-5, and are representative of generally other arrangements of force sensor conductors 206 where the geometry of the force sensor conductors 206 can be modeled as a series of columns, among others. In FIG. 6, the combination sensor conductors 204 and force sensor conductors 206 are assigned the subscript N, where N is a positive integer. The force sensor conductor 206₁ and 206_{N} represent the force sensor conductors 206 positioned closest to the opposite edges of the substrate on which the force sensor conductors 206 are formed, with the force sensor conductors 206₂ through the force sensor conductors 206_{N-1} arranged sequentially therebetween. In some embodiments, the force sensor conductors 206_{N} are coupled at respective ends 210_{N}, 212_{N} to the sensor model 208 in the manner described with reference to FIG. 2. In other embodiments, the ends 210_{N} of the force sensor conductors 206_{N} are coupled to the receiver module 254 of the sensor model 208, for example, when performing transcapacitive sensing using the capacitive sensor conductors 202_{N} configured as illustrated in FIGS. 4 and 5 as an example. Additionally, as described above, each combination sensor conductor 204_{N} has an associated capacitive sensor conductor 202_{N} (not shown in FIG. 6, but as illustrated and described with reference to FIGS. 2-5 above).

Additionally shown in FIG. 6 are optional switching circuitries 602, 604, 608. The switching circuitry 602 is interfaced with the routing 214 connecting the first ends 210_{N} of the force sensor conductors 206_{N} to the driver module 250. The switching circuitry 602 comprises one or more multiplexers or other switching logic operable to couple one or more of the force sensor conductors 206_{N} to the driver module 250. The switching circuitry 602 multiplexes gangs of selected force sensor conductors 206_{N} to form a larger force sensor conductor 206 on which the force sensing signal is driven while the processing system 110 is operating in the second mode for force sensing. The force sensor conductors 206 ganged in parallel have a smaller resistance as compared to the resistance of a single one of the force sensor conductors 206, which can be useful in bringing the sensing circuit into a more suitable range for measuring resistance for a particular configuration . Additionally, as the capacitive sensor conductors 202_{N} of the combination sensor conductors 204_{N} included with the force sensor conductors 206_{N}, the switching circuitry 602 is also operable to gang selected capacitive sensor conductors 202_{N} to enable larger conductors to be utilized for capacitive sensing while the processing system 110 is operating in the first mode. Larger conductors for capacitive sensing generally improve signal response and provide improved flexibility of touch sensing techniques. Alternatively, two or more force sensor conductors 206_{(M, N)} may be ganged in series connection, for example, by utilizing switch 602 to connect driver 250 to (for example) conductor 206_{N}; further utilizing switches 258_{N}, 604, and 258_{N-1}, to connect conductor 206_{N} to conductor 206_{N-1}; and finally utilizing switch 602 to connect conductor 206_{N-1} to receiver 254. As ganging two or more force sensor conductors 206_{(M, N)} in series increases the resistance as compared to the resistance of a single one of the force sensor conductors 206, serial ganging can be useful in bringing the sensing circuit into a more suitable range for measuring resistance for a particular configuration.

The optional switching circuitry 608 is utilized in embodiments wherein the second state of the switch 258_{N} selectively connects the second ends 212_{N} of the combination sensor conductors 204_{N} to the driver module 250. When the ends 210_{N}, 212_{N} of the combination sensor conductors 204_{N} are both coupled to the driver module 250 while the processing system 110 is operating in the first mode for capacitive sensing, the combination sensor conductors 204_{N} now operating as or as part of the capacitive sensor conductors 202_{N} can be rapidly driven with capacitive sensing signal, thus improving settling times and allowing faster touch sensing to be performed. The switching circuitry 608 is interfaced with the routing 260 and comprises one or more multiplexers or other switching logic operable to couple one or more of the capacitive sensor conductors 202_{N} of the combination sensor conductors 204_{N} to the driver module 250. The switching circuitry 608 is used in conjunction with the switching circuitry 602 to multiplexing gangs of selected capacitive sensor conductors 202_{N} from both ends 210_{N}, 212_{N} of the combination sensor conductors 204_{N} to form a larger capacitive sensor conductor 202 for the benefits discussed above.

The optional switching circuitry 604 is interfaced with the routing 216 connecting the second ends 212_{N} of the force sensor conductors 206_{N} to the receiver module 254 when the switch 258 is in the second state for force sensing while the processing system 110 is operating in the second mode. The switching circuitry 604 comprises one or more multiplexers or other switching logic operable to couple one or more of the force sensor conductors 206_{N} to the driver module 250. The switching circuitry 604 is used in conjunction with the switching circuitry 602 to multiplexing gangs of selected force sensor conductors 206_{N} from both ends 210_{N}, 212_{N} to form a larger force sensor conductor 206 for the benefits discussed above.

The operation of the input device 100 schematically illustrated in FIG. 6 while the processing system 110 has generally been discussed above. In the first mode of operation, the processing system 110 selectively operates in at least the first mode for capacitive sensing and the second mode for forces sensing. The mode of operation of the processing system 110 causes the configuration of the combination sensor conductors 204 to be switched between capacitive sensor conductors 202 and force sensor conductors 206. As discussed above, the combination sensor conductors 204 when functioning as capacitive sensor conductors 202, may operate in a transcapacitive, absolute or other capacitive touch sensing technique. The combination sensor conductor 204 when functioning as force sensor conductors 206, may operate by detecting a metric indicative of force applied to the input device 100 by sensing a change in the resistance of the force sensor conductor 260 due to bending of the input device, which is more clearly illustrated with reference to FIGS. 7 and 8 described below.

FIGS. 7 and 8 are schematic sectional views of the input device 100 comparatively illustrating deflection of an input surface 720 of a cover lens 700 and force sensor conductors 206 upon application of a force by an input object (140) to the input surface 720. The sensing region 120 generally overlaps the input surface 720 of the input device 100 in the illustration of FIGS. 7 and 8. The force applied by the input object to the input surface 720 is illustrated by arrow designated by reference numeral 800 in FIG. 8.

Continuing to refer to both FIGS. 7 and 8, the cover lens 700 of the display 180 is generally supported at the edges 702, 704 of the cover lens 700 by mounting structures 706. The mounting structure 706 may be part of the chassis of the input device 100. Although only the edges 702, 704 of the cover lens 700 visible in the X-Z sectional view of FIGS. 7 and 8, the edges of the cover lens 700 that would be shown in a Y-Z cross section are also supported by mounting structures 706. Thus, the cover lens 700 is supported by the mounting structures 706 about the perimeter edges of the cover lens 700. When no force is applied to the cover lens 700, the input surface 720 is substantially planar, and is coplanar with a dashed line representing an imaginary plane 710.

When a force 800 is applied to the input surface 720 of the cover lens 700, the cover lens 700 and force sensor conductors 206 positioned thereunder are displaced in the direction of the force. For example, application of the force 800 to the input surface 720 of the cover lens 700 displaces the input surface 720 of the cover lens 700 and the underlying force sensor conductor 206 a distance 802 from the imaginary plane 710. The displacement of the force sensor conductor 206 due to bending increases the length of the force sensor conductor 206, which causes a change in the resistance of the force sensor conductor 206. As the force sensor conductor 206 is coupled to the receiver module 254 while the processing system 110 is operating in the second mode, a metric of the change in resistance can be measured. For example, the metric of the change in resistance of the force sensor conductor 206 can be measured distance by integrating the charge driven on to the force sensor conductor 206 by the driver module 250 using the AFEs of the receiver module 254.

The determination module 256 can utilize the information provided by the receiver module 254 to equate the measured charge to a change in resistance, and thus to a force applied to the input surface 720 of the cover lens 700. The determination module 256 can derive the force associated with the information provided by the receiver module 254 utilizing a look-up table, a model, mapping, algorithm or other suitable technique.

Utilizing the bending characteristics of the cover lens 700 and underlying structures, such as force sensor conductors 206, to derive a force applied to the input surface 720 can be improved by adding information as to the location of where the force 800 is applied to the input surface 720 to the determination of the force. For example, the amount of bending of the cover lens 700 and underlying force sensor conductors 206 is a function of the location on the input surface 720 to which that the force 800 is applied. For example as illustrated in FIG. 8, the force 800 is applied offset from a center line 708 of the input surface 720. As the cover lens 700 is supported at its edges 702, 704 by the mounting structure 706, the distance 802 of the displacement of the input surface 720 due to a given amount of force will vary, and generally diminish, as the location of the force application (shown by distance 804) moves farther from the center line 708 of the cover lens 700. Although, the distance 804 is only show in the X direction in FIG. 8, the effect on displacement is also a function of the location of the force application in the Y-direction for the same reason. Accordingly, the determination module 256 may be configured to determine the force as a function of both deflection, as determined by force sensing in the second mode, and X-Y position of the application of the force 800, as determined by sensing touch of the input object by capacitive sensing in the first mode.

In one example, force as a function of deflection and position may utilize empirical data to create a look-up table that equates force to the amount of deflection of the cover lens 700 as determined by the change in resistance of the force sensor conductors 206 and the X-Y position of the input object 140 exerting the force 800 on the input surface 720 as determined by capacitive sensing utilizing the capacitive sensor conductors 202. As the combination sensor conductors 204 can be configured by operation of the processing system 110 as either the force sensor conductors 206 and the capacitive sensor conductors 202, the amount of conductors needed, along with the space within the input device 100 is advantageously minimized as compared to conventional devices that utilize dedicated force sensing electrodes or other electrodes that are not part of capacitive sensing electrode arrangement.

In another example, force as a function of deflection and X-Y position may utilize a model, algorithm or mapping technique that equates force to the amount of deflection of the cover lens 700. The model, algorithm or mapping technique utilizes the change in resistance of the force sensor conductors 206 as one variable and the position of the input object 140 exerting the force 800 on the input surface 720 as a second variable. Alternatively, the model or mapping technique may utilize best fit comparisons between modeled force and position deflection models to the force and position information obtained utilizing the combination sensor conductors 204.

In another example, the detection portion of the force measurement may be determined by comparing the change in resistance between two spatially separated force sensor conductors 206. The spatially separated force sensor conductors 206 may optionally be in close proximity, however, utilizing one force sensor conductor 206 located near an edge (i.e., perimeter) of the input device 100 as a baseline for comparison to another force sensor conductor 206 located spatially inward of the end of the input device 100 (such as near the center) will provide more accurate force information. For example and referring to FIG. 6 in addition to FIGS. 7-8, the force sensor conductors 206₁ and 206_{N} located near edges 680, 682 of the substrate 402 on which the force sensor conductors 206 are formed will generally deflect less than force sensor conductors 206, such as force sensor conductor 206_{N/2}, disposed near or at the center of the substrate 402. In some instances, the force sensor conductors 206₁ and 206_{N} located near edges 680, 682 of the substrate 402 may have little or no change in resistance compared to the force sensor conductor 206_{N/2} or other force sensor conductors 206 space away from the edges 680, 682 of the substrate 402. Thus, the resistance of the force sensor conductors 206₁ and 206_{N} located near edges 680, 682 of the substrate 402 may be utilized as a baseline for comparison to the resistance of another force sensor conductor 206 to provide an indicia of deflection.

During some force sensing implementations, two force sensor conductors 206 may be driven by the driver module 250 with force sensing signals having identical waveforms of opposite polarities. When the two force sensor conductors 206 are perfectly matched under “no-force” condition, the resulting signals at from each force sensor conductors 206 cancel each other, and thus, no net different is detected by the receiver module 254. When force 800 is applied, the resistance of one of the force sensor conductors 206 changes with respect to the resistance of the other force sensor conductor 206, resulting in a non-zero sum of the resulting signals received by the receiver module 254. The difference may be amplified by sensor circuitry in the receiver module 254 or the determination module 256, and the resulting signal is used to by the determination module 256 to infer the magnitude of the applied force. As discussed above, the addition of information relating to the force application location may be utilized to further improve the accuracy of the force determination. In one example, the combination sensor conductors 204 include the same force sensor conductors 206 utilized to measure the change in resistance and the same capacitive sensor conductors 202 utilized to detect the location of the application of the force by the input object 140 to the cover lens 700. One of the force sensor conductors 206 in each pair is (preferably) the outmost top or bottom force sensor conductors 206₁/206_{N} of the two dimensional array may be utilized as a baseline reference for comparison to a second force sensor conductor 206 that is located closer the middle of the input surface 720 where the deflection distance 802 and associated strain are significant and, thus experience change in resistance.

Additionally, the determination module 256 may utilize positional information obtained using the capacitive sensor conductors 202 to compensate for positional information of the input object applying the force 800 to the input surface 720. For example, the maximum deflection of the input surface 720 is often not positionally under the location of the application of the force 800. Thus, the positional information can be utilized to more accurately determine the actual force 800 applied to the input surface 720.

In another example, positional information may be utilized by the determination module 256 to select a mapping of face versus deflection associated with the particular location of the input object 140. The determination module 256 determines the deflection of the input surface 720 due to the force 800. The determination module 256 then determines the amount of force applied of the input surface 720 by mapping the determined deflection to a force using the mapping associated with the location that the force 800 is applied.

Furthermore, the measurements of displacement (via resistance change) and capacitive response may be further compensated by using the internal course biasing correction and baseline subtraction. Slow drift due to temperature variations that could result in the force baseline drift can be eliminated through know algorithms similar to those conventionally utilized to account for drive in capacitive sensing baselines.

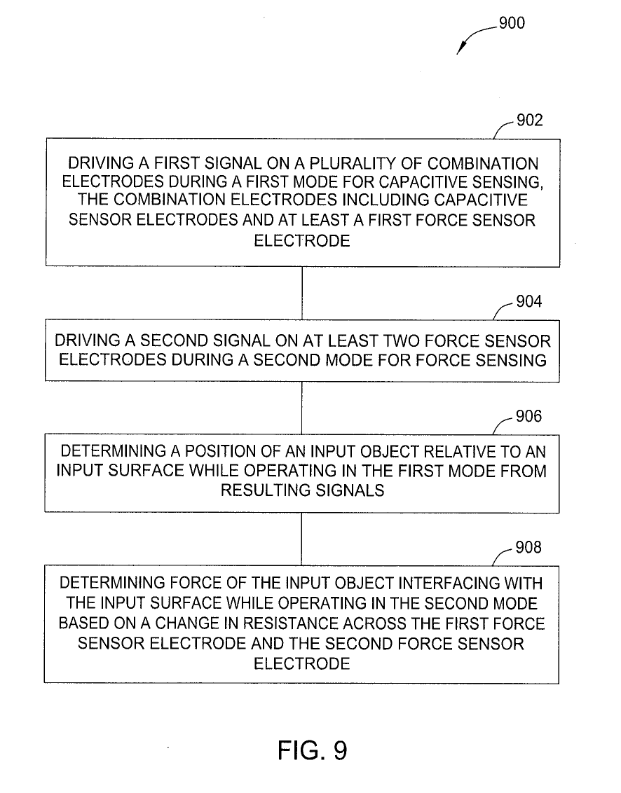

FIG. 9 is a block diagram for a method 900 for sensing force and position using an input device, such as the input device 100 described above, among others. The method 900 includes driving a first signal on a plurality of combination sensor conductors during a first mode for capacitive sensing at operation 902. The combination sensor conductors include a plurality of capacitive sensor conductors and at least one a force sensor conductor.

At operation 902, a second signal is driven on at least two force sensor conductors during a second mode for force sensing. At operation 904, a position of an input object relative to an input surface is determined while operating in the first mode from resulting signals. At operation 906, force of the input object interfacing with the input surface is determined while operating in the second mode based on a change in resistance across the first force sensor conductor and the second force sensor conductor.

Certain examples of the disclosed technology are provided in the claims that follow. It is contemplated that the disclosed technology may also be expressed in other embodiments, including but not limited to the examples provided below.

In a first example, an input device is provided that includes an input surface; a plurality of combination sensor conductors, the combination sensor conductors including capacitive sensor conductors and at least two force sensor conductors; a touch driver coupled to a first end of each of the force sensor conductors; a receiver; and a first switching circuitry operable to couple a second end of each of the force sensor conductors to the receiver.

In a second example, a capacitive sensor conductor of the plurality of capacitive sensor conductors of the input device of the first example further comprises a plurality of receiver sensor conductors; and a plurality of plurality of transmitter sensor conductors, wherein the transmitter sensor conductors include the force sensor conductors.

In a third example, the input device of the first example further includes a trace coupling each force sensor conductor to a unique one of the plurality of capacitive sensor conductors.

In a fourth example, the force sensor conductors of the input device of the first example further includes a first force sensor conductor disposed proximate an edge of the input surface; and a second force sensor conductor disposed proximate a center region of the input surface.

In a fifth example, the force sensor conductors of the input device of the first example are substantially equal in length.

In a sixth example, the input device of the first example further includes a second switching circuitry operable to simultaneously couple the first ends of at least two of the two or more force sensor conductors to the touch driver through a common routing.

Thus, the embodiments and examples set forth herein were presented in order to best explain the embodiments in accordance with the present technology and its particular application and to thereby enable those skilled in the art to make and use the present technology. However, those skilled in the art will recognize that the foregoing description and examples have been presented for the purposes of illustration and example only. The description as set forth is not intended to be exhaustive or to limit the disclosure to the precise form disclosed.

In view of the foregoing, the scope of the present disclosure is determined by the claims that follow.

We claim:

1. An input device comprising
an input surface;
a plurality of combination sensor conductors comprising:
a first combination sensor conductor configurable between being a first capacitive sensor conductor of a plurality of capacitive sensor conductors and a first force sensor conductor, the first capacitive sensor conductor and the first force sensor conductor sharing a same first conductive portion; and
a second combination sensor conductor configurable between being a second capacitive sensor conductor of the plurality of capacitive sensor conductors and a second force sensor conductor, the second capacitive sensor conductor and the second force sensor conductor sharing a same second conductive portion;
a display configured to display images through the input surface; and
a processing system communicatively coupled to the plurality of combination sensor conductors, the processing system configured to:
determine positional information for an input object present in a sensing region overlapping the input surface using at least the first capacitive sensor conductor of the plurality of capacitive sensor conductors; and
determine force applied to the input surface of the display by the input object based on a change in a first resistance across the first force sensor conductor and a change in a second resistance across the second force sensor conductor.

2. The input device of claim 1, wherein the processing system, when determining force applied to the input surface, is configured to determine force further based on the positional information of the input object.

3. The input device of claim 1, wherein the processing system, when determining force applied to the input surface, is configured to utilize a resistance across the first force sensor conductor as a baseline when processing the change in resistance across the second force sensor conductor.

4. The input device of claim 1, wherein the plurality of capacitive sensor conductors extend across the input surface in a parallel orientation.

5. The input device of claim 1, wherein the first and second force sensor conductors are substantially equal in length.

6. The input device of claim 1, wherein the first force sensor conductor comprises:
a routing trace extending across the input surface.

7. The input device of claim 1, wherein the second force sensor conductor is disposed proximate a center of the input surface, and wherein the first force sensor conductor is disposed proximate a perimeter of the input surface.

8. A processing system for an input device, comprising:
a driver module configured to:
drive a plurality of combination sensor conductors during a first mode for capacitive sensing, the plurality of combination sensor conductors comprising:
a first combination sensor conductor configurable between being a first capacitive sensor conductor of a plurality of capacitive sensor conductors and a first force sensor conductor of a plurality of force sensor conductors, the first capacitive sensor conductor and the first force sensor conductor sharing a same first conductive portion; and
a second combination sensor conductor configurable between being a second capacitive sensor conductor of the plurality of capacitive sensor conductors and a second force sensor conductor of the plurality of force sensor conductors, the second capacitive sensor conductor and the second force sensor conductor sharing a same second conductive portion; and
drive at least the first and second force sensor conductors during a second mode; and
a receiver module configured to:
receive first resulting signals indicative of a position of the input object interfacing with an input surface of the input device while the driver module is operating in the first mode, and
receive second resulting signals indicative of a force of the input object interfacing with the input surface while the driver module is operating in the second mode.

9. The processing system of claim 8 further comprising:
a determination module configured to determine the force of the input object interfacing with the input surface based on the second resulting signals, the second resulting signals indicative of a first change in resistance across the first force sensor conductor and of a second change in resistance across the second force sensor conductor.

10. The processing system of claim 9, wherein the determination module, when determining force applied to the input surface, is configured to determine force further based on the position of the input object interfacing with the input surface.

11. The processing system of claim 9, wherein the determination module, when determining force applied to the input surface, is configured to determine force based on:
a mapping of force versus displacement; and
a capacitive response of the plurality of combination sensor conductors.

12. The processing system of claim 9, wherein the determination module, when determining force applied to the input surface, is configured to utilize a resistance across the first force sensor conductor as a baseline for processing a resistance across the second force sensor conductor.

13. The processing system of claim 8 further comprising:
switching circuitry operable to selectively couple an end of each of the first and second force sensor conductors to the receiver module.

14. The processing system of claim 8 further comprising:
switching circuitry operable to simultaneously couple the second force sensor conductor and another force sensor conductor of the plurality of force sensor conductors to the driver module through a common routing.

15. The processing system of claim 14, wherein the second force sensor conductor and the another force sensor conductor are coupled in parallel.

16. A method for sensing force and position using an input device, comprising:
driving a plurality of combination sensor conductors during a first mode, the plurality of combination sensor conductors comprising:
a first combination sensor conductor configurable between being a first capacitive sensor conductor of a plurality of capacitive sensor conductors and a first force sensor conductor of a plurality of force sensor conductors, the first capacitive sensor conductor and the first force sensor conductor sharing a same first conductive portion; and
a second combination sensor conductor configurable between being a second capacitive sensor conductor of the plurality of capacitive sensor conductors and a second force sensor conductor of the plurality of force sensor conductors, the second capacitive sensor conductor and the second force sensor conductor sharing a same second conductive portion; and
driving the first force sensor conductor of the plurality of the force sensor conductors during a second mode;
determining a position of an input object interfacing with an input surface of the input device from resulting signals comprising effects of at least one signal driven during the first mode on the plurality of combination sensor conductors; and
determining force of the input object applied to the input surface based on a first change in resistance across the first force sensor conductor and a second change in resistance across the second force sensor conductor occurring during the second mode.

17. The method of claim 16, wherein the determining force of the input object applied to the input surface comprises:
compensating for the position of the input object relative to the input surface.

18. The method of claim 16, wherein the determining force of the input object applied to the input surface comprises:
processing the second change in resistance across the second force sensor conductor relative to a baseline resistance of the first force sensor conductor.

19. The method of claim 16 further comprising:
selectively coupling an end of each of the plurality of force sensor conductors to a receiver module.

20. The method of claim 16 further comprising:
simultaneously coupling the second force sensor conductor and another force sensor conductor of the plurality of force sensor conductors to a driver module through a common routing.
